(19) United States
(12) Patent Application Publication
(10) Pub. No.: US 2026/0241595 A1
(43) Pub. Date: Aug. 20, 2026

(54) SYSTEMS AND METHODS FOR PRODUCING PEELED MATERIALS

(71) Applicant: The Texas A&M University System, College Station, TX (US)

(72) Inventors: Dinakar Sagapuram, Bryan, TX (US); Prabhakar R. Pagilla, College Station, TX (US); Aditya Yalamanchili, Bryan, TX (US); Parth Dave, College Station, TX (US); Ravi Srivatsa Bindiganavile Narasimhan, Bryan, TX (US); Boliang Meng, College Station, TX (US); Ashish Devkota, College Station, TX (US)

(73) Assignee: The Texas A&M University System, College Station, TX (US)

(21) Appl. No.: 19/054,384

(22) Filed: Feb. 14, 2025

(51) Int. Cl. B26D 3/28; B26D 1/04; B26D 7/18

(52) U.S. Cl. CPC B26D 3/282; B26D 1/04; B26D 7/1836; Y10T 29/307

(57) ABSTRACT

A system for forming a peeled material from a rotating feedstock includes a peeling subsystem including a cutting tool configured to peel a continuous peeled material from a surface of the feedstock, a tensioning subsystem including one or more rollers defining a travel path of the peeled material and a tensioning device for applying tension to the peeled material, and a closed-loop controller operatively connected to the tensioning subsystem for controlling a thickness of the peeled material by adjusting an amount of tension applied by the tensioning device to the peeled material.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND

Material working refers to a diverse array of processes for shaping feedstocks (e.g., metals, plastics) to create useful products. Material working includes material forming where objects are fashioned from feedstock in the form of a workpiece through mechanical deformation (e.g., plastic deformation) of the workpiece whereby the workpiece is reshaped. In some instances, material forming involves forming elongate materials having a predefined cross-sectional geometry (e.g., sheets, strips, wires, coils). Material forming includes both compressive forming processes (e.g., rolling, extrusion, die forming, forging, and indenting) where the workpiece is mechanically deformed through compressive loading, and tensile forming processes (e.g., stretching, expanding, and recessing) in which the workpiece is mechanically deformed through tensile loading.

### BRIEF SUMMARY OF THE DISCLOSURE

An embodiment of a system for forming a peeled material from a rotating feedstock comprises a peeling subsystem comprising a cutting tool configured to peel a continuous peeled material from a surface of the feedstock, a tensioning subsystem comprising one or more rollers defining a travel path of the peeled material and a tensioning device for applying tension to the peeled material, and a closed-loop controller operatively connected to the tensioning subsystem for controlling a thickness of the peeled material by adjusting an amount of tension applied by the tensioning device to the peeled material. In some embodiments, the system comprises an accumulator for varying a speed of the peeled material along the travel path. In some embodiments, the accumulator comprises one or more idler rollers defining the travel path extending between the one or more idler rollers, and the accumulator has an unengaged state in which the travel path has a first longitudinal length, and the accumulator has an engaged state in which the travel path has a second longitudinal length that is greater than the first longitudinal length. In some embodiments, the accumulator comprises an accumulator motor configured to transition the accumulator between the unengaged stated and the engaged state. In some embodiments, the system comprises a speed sensor for monitoring the speed of the peeled material, and wherein the closed-loop controller is configured to control the operation of the accumulator motor to maintain a leading edge of the peeled material passing from the accumulator at a predefined splicing speed. In some embodiments, the accumulator is configured to selectably maintain a leading edge of the peeled material passing from the accumulator at a predefined splicing speed that is equal to zero. In some embodiments, the tensioning device comprises a plurality of tensioning rollers with the travel path of the peeled material extending between the plurality of tensioning rollers. In some embodiments, the plurality of tensioning rollers define an S-swap roller. In some embodiments, the plurality of tensioning rollers comprise a plurality of pinch rollers. In some embodiments, the tensioning device comprises a coiler for coiling the peeled material. In some embodiments, the peeled material comprises at least one of strip material, wire material, sheet material, and foil material.

An embodiment of a system for forming a peeled material from a rotating feedstock comprises a peeling subsystem comprising a cutting tool configured to peel a continuous peeled material from an outer surface of the feedstock, a tensioning subsystem comprising one or more rollers defining a travel path of the peeled material and a tensioning device for applying tension to the peeled material, a sensor for determining at least of surface speed of the peeled material along the travel path, a tension of the peeled material, and a thickness of the peeled material, and a closed-loop controller comprising a processor and a memory device encoded with instructions that, when executed by the processor, cause the processor to control the operation of the tensioning subsystem to control at least one of the surface speed, the tension, and thickness of the peeled material based on feedback data provided by the sensor. In some embodiments, the instructions of the closed-loop controller, when executed by the processor, cause the processor to maintain the peeled material at at least one of a predefined setpoint thickness, a predefined setpoint tension, and a predefined setpoint surface speed along the travel path. In some embodiments, the feedback data comprises tension data and the instructions of the closed-loop controller, when executed by the processor, cause the processor to control the operation of the tensioning subsystem to control the tension of the peeled material. In some embodiments, the sensor comprises a load cell. In some embodiments, the feedback data comprises thickness data and the instructions of the closed-loop controller, when executed by the processor, cause the processor to control the operation of the tensioning subsystem to control the thickness of the peeled material. In some embodiments, the sensor measures the thickness of the peeled material.

An embodiment of a system for peeling a coiled product from a cylindrical workpiece comprises a peeling subsystem comprising a cutting tool feedable in a first longitudinal direction to peel a continuous strip of material from a radially outer surface of the workpiece as the workpiece rotates about a rotational axis that extends parallel the first longitudinal direction. In some embodiments, the peeling subsystem comprises a tool holder configured to advance the cutting tool linearly along the first longitudinal direction. In some embodiments, the cutting tool has at least one of a linearly extending cutting edge and an annular cutting edge.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of exemplary embodiments of the disclosure, reference will now be made to the accompanying drawings in which:

FIG. 1 is a schematic view of an exemplary conventional material forming process;

FIG. 2A is a schematic view of an embodiment of a material forming system;

FIG. 2B is a zoomed-in side view of the material forming system of FIG. 2A;

FIG. 3 is a schematic view of an embodiment of a material peeling system;

FIG. 4 is a schematic view of another embodiment of a material peeling system;

FIG. 5 is a schematic view of another embodiment of a material peeling system;

FIG. 6 is a perspective view of an embodiment of a peeling subsystem;

FIG. 7 is a top view of an embodiment of a feedstock holder;

FIG. 8 is a perspective view of an embodiment of a tool support;

FIG. 9 is a schematic view of another embodiment of a material peeling system;

FIG. 10 is a flowchart of an exemplary method for forming a finished product comprising peeled material;

FIGS. 11-13 are additional schematic views of the material peeling system of FIG. 9;

FIG. 14 is a perspective view of an embodiment of an accumulator;

FIG. 15 is a graph of parameters of an exemplary material peeling system;

FIG. 16 is a graph of strip tension of an exemplary material peeling system;

FIG. 17 is a block diagram of an embodiment of a closed-loop controller;

FIG. 18 is a schematic view of an embodiment of a tensioning device;

FIG. 19 is a schematic view of another embodiment of a tensioning device;

FIG. 20 is a schematic view of another embodiment of a tensioning device;

FIG. 21 is a block diagram of another embodiment of a closed-loop controller;

FIG. 22 is a block diagram of another embodiment of a closed-loop controller;

FIG. 23 is a graph illustrating strip tension of an exemplary material peeling system;

FIG. 24 is a graph illustrating surface speed of an exemplary material peeling system;

FIG. 25 is a graph illustrating coil diameter of an exemplary material peeling system;

FIG. 26 is a graph illustrating different rotational speeds of an exemplary material peeling system;

FIG. 27 is a block diagram of another embodiment of a closed-loop controller;

FIG. 28 is a graph illustrating strip tension of an exemplary material peeling system;

FIG. 29 is a graph illustrating surface speed of an exemplary material peeling system;

FIG. 30 is a graph illustrating coil diameter of an exemplary material peeling system; and

FIG. 31 is a graph illustrating different rotational speeds of an exemplary material peeling system; and

FIGS. 32 and 33 are block diagrams of additional embodiments of closed-loop controllers.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis. Further, as used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

As described above, material forming processes apply compressive, tensile and/or shear loads to a workpiece whereby the workpiece is mechanically deformed into a usable product. As an example, finished product in the form of sheet metal is typically mass produced using a material working (or metalworking in this example) process referred to as “rolling.” This process generally involves the application of significant thickness reduction strains whereby feedstock in the form of 6″-10″ thick cast ingot or slab is reduced in thickness to final sheet form via multiple rolling passes. As used herein, the term “feedstock” refers to the initial state of a workpiece (i.e., the physical material worked on or formed by the material forming process) formed into a finished product by the material forming process. In addition, while the term “finished product” is used herein to describe the final state of the workpiece formed by the material forming process, the “finished product” may undergo additional manufacturing processes before being sold or used in a given application (e.g., a given industrial application).

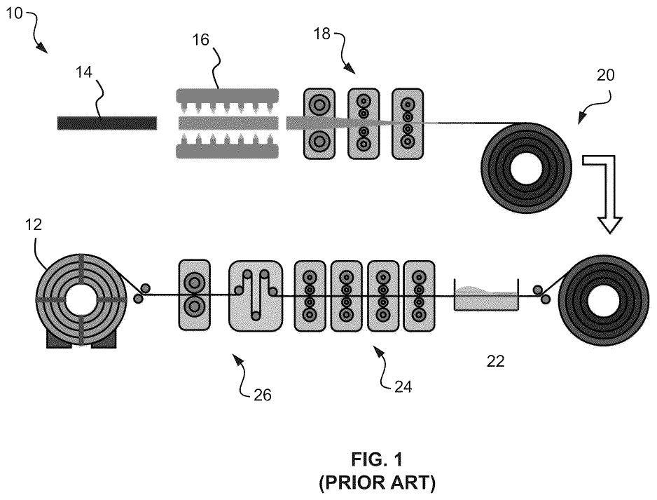

To provide a brief illustrative example, reference is initially made to FIG. 1 which illustrates an exemplary conventional material forming system 10 in the form of a rolling process for producing a finished product 12 in the form of coiled, strip material (e.g., strip steel) from a feedstock in the form of a slab 14 (e.g., slab steel).

In this example, conventional material forming system 10 generally includes a reheating unit 16, a hot rolling unit 18, a pickling unit 22, a cold rolling unit 24, and an annealing and tempering unit 26. Reheating unit 16 heats the slab 14 such that slab 14 is at a desired elevated temperature as it is rolled by the hot rolling unit 18 whereby the original slab 14 is transformed into an intermediate rolled coil 20 (e.g., between approximately 2 mm and 6 mm thick). To achieve further thickness reductions, the intermediate rolled coil 20 is unspooled and pickled using unit 22 prior to being subjected to one or more cold rolling passes by the cold rolling unit 24. Following cold rolling, the workpiece is annealed and tempered by the annealing and tempering unit 26 to thereby form the finished product 12.

The as-cast feedstock of conventional material forming processes such as rolling processes (e.g., the system 10 shown in FIG. 1) typically undergoes breakdown rolling or forging for homogenization, followed by hot rolling to accomplish the desired reduction in thickness. Hot rolling of the workpiece may then be followed by multiple steps of cold rolling thereof to achieve the final desired thickness and tolerances for the finished product.

For metals like steels, pre-heat temperatures during the breakdown and hot rolling stages of the process described above are typically greater than 1,000 degrees Celsius (° C.). A substantial fraction of the heat produced during these stages is lost to the external environment (e.g., during the period that occurs between the breakdown and hot rolling stages), and therefore additional heat treatments are often required between these steps to maintain the workpiece at the desired (substantially elevated) temperature.

Accordingly, breakdown hot rolling and other stages of conventional material forming processes such as rolling processes consume substantial amounts of energy particularly in view of the poor thermal efficiency of such techniques. Additionally, processes like scalping and pickling that are used to remove surface oxide scale that form on the workpiece as a result of high-temperature heating contribute to permanent material losses during forming of the finished product.

Further, rolling of alloys that exhibit high work-hardening rates or limited cold ductility (e.g., stainless steel, magnesium, titanium, nickel-based alloys, and refractory metals) consumes substantial amounts of energy due to the need for applying annealing heat treatments to the workpiece in between separate rolling stages to prevent the workpiece from cracking. A particularly illustrative example of this phenomenon is magnesium, rolling of which often requires a feedstock in the form of a pre-conditioned extruded or forged slab to avoid detrimental properties of the as-cast structure on rolling properties. Furthermore, because of the poor workability of magnesium, this material forming process requires frequent reheating of the workpiece in off-line ovens to maintain the workpiece at the desired temperature (e.g., between 250° C. and 450° C.) for hot rolling of the workpiece. Even at these temperatures, the rollers or simply “rolls” must be maintained in a preheated condition, and a substantial number (e.g., 12-18) reverse hot rolling passes of the workpiece are required.

Typically, the next stage of rolling material forming processes involves transferring the workpiece in the form of a “reroll” coil from a hot mill for warm rolling of the workpiece at about 350° C. to a sheet thickness of a few mm (e.g., 2 mm), which is then followed by cold rolling of the workpiece. To prevent cracking during cold rolling, the maximum reduction per pass is typically kept to less than 5% and the workpiece is subjected to intermediate annealing treatments to restore ductility. These final stages of rolling of this material forming process are especially time consuming and result in progressively lower material yields.

As outlined above, salient factors contributing to substantial energy consumption in at least some conventional material forming processes (e.g., material forming processes for forming finished products in the form of thin metal strips and sheets) include the necessary process heating, intermediate annealing heat treatments and frictional losses arising from multiple, discrete deformation or rolling stages of the material forming process. As a result, the overall onsite energy consumption in such conventional material forming processes is several orders of magnitude greater than the theoretical or ideal (assuming ideal conditions and zero energy losses) minimum energy required for forming the finished product. Furthermore, the specific energy (energy consumption per unit volume) is strip thickness dependent on the thickness of the given workpiece (e.g., the thickness of the given strip). Particularly, the specific energy increases exponentially with decreasing workpiece thickness due to the concomitant increase in the number of processing stages. In addition to considerations of energy efficiency, rolling the workpiece to foil thicknesses (e.g., less than 0.2 mm) is further limited by the “roll flattening” phenomenon and typically requires the use of sophisticated reversing mills (e.g., Sendzimir reversing mills sometimes referred to as “Z-mills”). In such reversing mills, smaller diameter rolls are supported by a series of larger backing rolls in order to prevent the work-roll bending.

The significant amount of energy consumed in forming finished products from feedstock using conventional material forming techniques (e.g., material forming processes for forming strip product from cast metal) also has important environmental implications. For instance, most of the energy (e.g., 85% of the energy) consumed in some material forming processes (e.g., steel rolling processes) is derived by burning fossil fuels (e.g., coal, natural gas) resulting in the corresponding production of CO2 emissions. As a result, the carbon intensity of, for example, conventional steel rolling processes alone is estimated to be approximately 0.4 tons of CO2 produced per ton of rolled strip, which translates to hundreds of millions of tons of CO2 emissions per year. In addition, the carbon intensity of rolling of other metals like aluminum are in a range of approximately 0.2 tons to 0.4 tons of CO2 produced per ton of rolled sheet.

Further, direct parallels between conventional material forming processes used for producing thin metal wires and those outlined above for producing strip and/or foil. Generally, metal wires are conventionally produced by a material forming process that includes multi-step drawing processes, where thin wires are produced from workpieces in the form of larger diameter rods by successively pulling (drawing) the wire through successively smaller dies. This multi-step process requires frequent annealing intervening steps in the case of relatively less ductile metals. Annealing temperatures for steel wire (in a non-oxidizing atmosphere) are typically within the range of approximately 700° C. and 800° C. with the total annealing time reaching approximately six to twelve hours depending on the steel grade. In addition, production of ultrathin wire cross-sections (e.g., approximately 50 micrometers (μm) in diameter) often used in electronics typically require thirty to forty separate drawing stages (or more for less ductile materials) to achieve the desired dimensions for the finished product. Moreover, due to the relatively larger surface area to volume ratio for ultrathin wires, the resulting friction generated by these processes imposes restrictions on the possible diameter reduction per pass and also contributes to significant wastage of the expended energy.

Embodiments of material forming systems are disclosed herein that address at least some of the limitations of conventional material forming systems described above through peeling material from an exterior surface of the feedstock to form the finished product. Metal peeling is a new alternative for manufacturing metal strip, sheet and wire forms directly from a cast metal feedstock. In this process, a thin layer of material is machined or peeled away from a solid surface via simultaneous action of cutting and pulling to produce continuous and controllable cross-sectional shapes (strip, wire and foil) in a single processing step. As used herein, the term “peeled material” is not limited by the aforementioned geometry and can take any geometric form, including, but not limited to, sheet, strip, foil, wire, and ribbon.

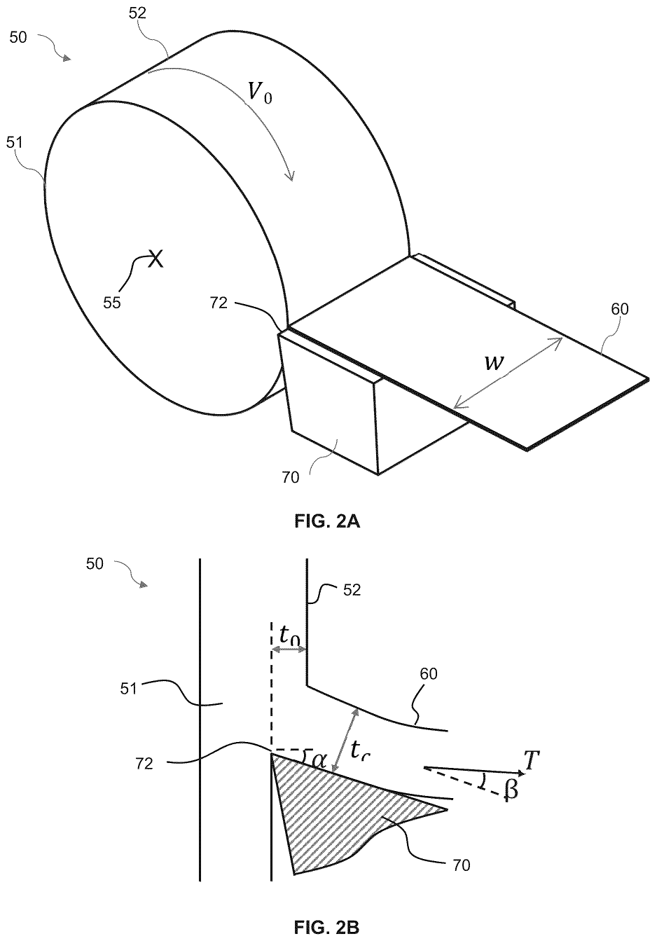

Referring now to FIGS. 2A and 2B, an embodiment of a material forming system 50 is shown for forming a feedstock 51 into a finished product 60 in the form of a peeled material. In this exemplary embodiment, material forming system 50 comprises a material peeling system in which the finished product 60 is peeled from the feedstock 51 by a cutting tool 70 of the material forming system 50. Additionally, in this exemplary embodiment, feedstock 51 is cylindrical in shape having an external surface in the form of a generally cylindrical radially outer surface 52 that is contacted or engaged by a cutting edge or surface 72 (e.g., a flat cutting surface) of the cutting tool 70 as the feedstock 51 rotates about a rotational axis 55 coincident with a longitudinal or central axis of the feedstock 51. In this configuration, the cutting edge 72 of cutting tool 70 continuously shaves or peels off the finished product 60 as peeled material having a thickness to and a width W corresponding to the longitudinal length of feedstock 51. In this exemplary embodiment, finished product 60 comprises a strip-shaped peeled material; however, in other embodiments, finished product may comprise peeled materials other than strip materials. For instance, finished product 60 may be in the form of a sheet, foil, or other elongate, thin materials (e.g., materials having a thickness that is substantially less than a longitudinal length thereof). Unlike conventional material handling processes, the peeling of finished product 60 from feedstock 51 involves cutting the feedstock 51 using the cutting tool 70 whereby material may be continuously removed from the feedstock 51. This concept to produce thin metal sheet, strip and foil (e.g., finished product 60) via material removal is fundamentally different from conventional rolling-based processes, in that the shape transformation from bulk to thin strip or wire cross-section may be accomplished, in some embodiments, in a single step.

An important advantage of peeling-based material forming methods (also referred to herein simply as “material peeling methods” or “material peeling systems”) over conventional methods (e.g., rolling methods) is that the intermediate processing steps (annealing treatments, surface oxide removal, removal of roll pick-up, sheet coiling/uncoiling, etc.) as well as large frictional energy losses intrinsic to multi-step conventional method like rolling and wire drawing are significantly reduced. In addition, for material peeling methods the deformation of the feedstock 51 is limited to a localized deformation zone whereby only a small volume of the feedstock 51 is subjected to plastic deformation at any given point in time. The location of the deformation zone eliminates or at least mitigates the need for external heating of the workpiece and is particularly beneficial for reducing energy consumption and associated carbon emissions in processing materials like steel or other materials of poor workability that conventionally require high-temperature heating of the workpiece material and corresponding tooling. Moreover, at least some material peeling methods may be entirely electrically powered, meaning the carbon footprint of the material peeling method is determined only by the carbon footprint of the electrical power itself (e.g., the carbon footprint required for producing the electrical power consumed by the method). Further, unlike conventional material forming methods like rolling and wire drawing, the specific energy in material peeling methods is independent of the strip thickness or wire cross-section of the finished product, enabling strip and wire production with significantly lower energy requirements.

In addition to energy and carbon emission savings discussed above, the material peeling methods are relatively more cost-effective than many conventional material forming methods given that material peeling methods are significantly less complex than some conventional material forming methods like multi-step rolling and drawing processes. Therefore, material peeling methods permit for the direct production of continuous, thin finished products in far fewer process steps within a smaller physical footprint. In some embodiments, this process modularity can not only facilitate strip and wire production close to the point of metal casting but can also provide a quicker investment return.

Still referring to FIGS. 2A and 2B, material forming system 50 may be operated by radially feeding the edge 72 of cutting tool 70 into contact with the outer surface 52 of feedstock 51 while simultaneously applying tension along the longitudinal axis of the finished product 60 as it is peeled from the feedstock 51. The strip width W of finished product 60 in this configuration is governed by the axial dimension of the cylindrical feedstock 51 while strip thickness t_{c} depends on various parameters, including the feed thickness t₀), the material and metallurgical state of feedstock 51, surface velocity V₀ of feedstock 51, lubricant, the material of cutting tool 70, the rake angle α and edge condition of cutting tool 70, the amount of tension T applied to the finished product 60 as it is being peeled from the feedstock 51, and the angle β at which finished product 60 is peeled with respect to the direction of the applied tension T.

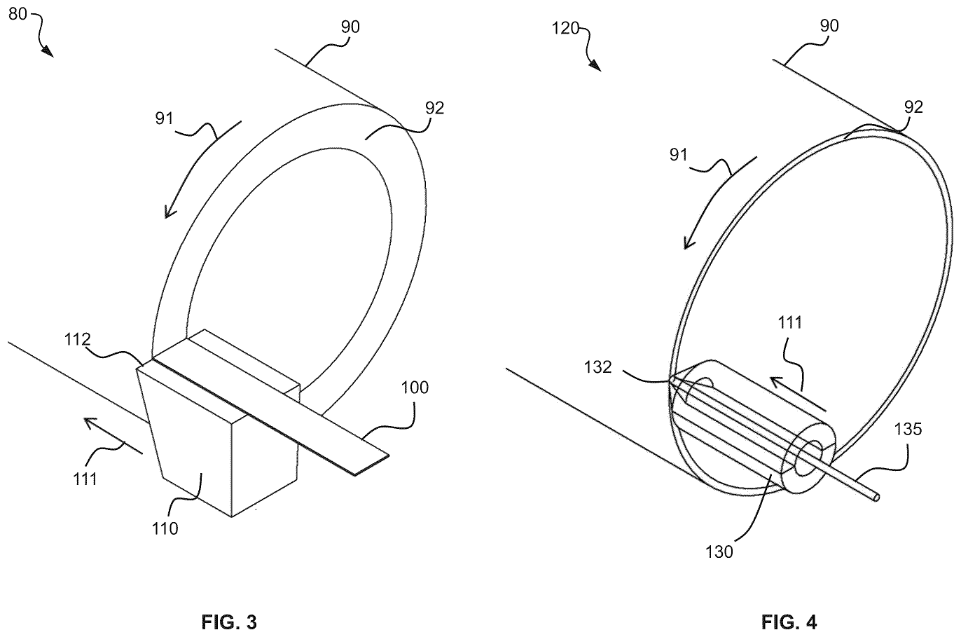

In certain embodiments, finished product in the form of narrow strip or wire may be formed using material peeling methods by utilizing a cutting tool or die geometry that forms an enclosed opening having a size based on the desired wire cross-sectional shape. As an example, and referring now to FIG. 3, an embodiment of a material peeling system 80 is shown for forming a feedstock 90 into a product 100 by peeling the product 100 from an external surface in the form of an annular longitudinal end 92 of the feedstock 90. Similar to material forming system 50 shown in FIGS. 2A and 2B, material peeling system 80 includes a cutting tool 110 having a cutting edge or surface 112 that engages and cuts into the longitudinal end 92 of feedstock 90 as the feedstock 90 rotates (indicated by arrow 91 in FIG. 3) about a longitudinal or central axis 95 of feedstock 90. In this exemplary embodiment, unlike system 50 shown in FIGS. 2A and 2B, a linear or longitudinal feed direction (indicated by arrow 111 in FIG. 3) is parallel to the rotational axis 95 of feedstock 90 whereas for material forming system 50 the feed direction of cutting tool 70 is orthogonal the rotational axis 55 of feedstock 51. Cutting tool 110 includes a tool holder 114 configured to feed the cutting tool 112 (having a linear cutting edge in this exemplary embodiment) along the feed direction 111. Additionally, a workpiece or feedstock holder 88 defines the rotational axis 95 of feedstock 90. For example, feedstock holder 88 may be configured to rotate the feedstock 90 about its respective rotational axis 95.

The configuration of material peeling system 80 (including the relationship between feed direction 111 and rotational direction 91) permits system 80 to produce product 100 in the form of thin wire or narrow strips without bending or buckling of the feedstock 90. Particularly, the cutting edge 112 of cutting tool 110 is flat or planar in configuration for generating product 100 in the form of a thin strip.

Referring to FIG. 4, another embodiment of a material peeling system 120 is shown in FIG. 4 similar in configuration to material peeling system 80 except that system 120 includes a cutting tool 130 having a curved (e.g., annular) or conical tip 132 for forming a product 135 in the form of a thin or small-diameter wire. Cutting tool 130 additionally includes a tool holder 134 for advancing the tip 132 linearly in a longitudinal feed direction that is parallel a rotational axis 95 of the feedstock 90.

For narrow strip and wire applications, the axial peeling configurations shown in FIGS. 3 and 4, where the cutting tool feed direction is parallel to the longitudinal (rotation) axis of the feedstock, are often more suitable than peeling systems having the cutting tool feed direction orthogonal the rotational axis. Material forming systems 80 and 120 utilize a cylindrical tube feedstock 90 for narrow-width strip and wire production, respectively. As noted earlier, in the case of wire production, a range of cross-sectional sizes and shapes (e.g., circular, prismatic, etc.) may be produced by controlling the geometry of the cutting tool (e.g., cutting tools 70, 110, and 130 illustrated in FIGS. 2-4, respectively) of the material peeling system. In addition, cutting tool configurations presented herein should be considered only as non-limiting examples. In addition to reducing the carbon footprint and energy demands for forming materials as compared with conventional material forming methods like rolling, material peeling methods may form finished products having a higher quality than that produced by conventional methods in terms of their dimensional, mechanical, and surface properties.

Generally, material peeling system 150 allows for uninterrupted production of a finished product 154 comprising peeled material in the form of, in this exemplary embodiment, continuous strip coil (e.g., coiled strip) from ferrous or non-ferrous metals, alloys, and other materials. The material peeling system 150 provides a non-limiting example for the case of radial peeling configuration. The material peeling system 150 may be logically broken down into a peeling subsystem 151 including a cutting tool 156, a splicing subsystem 162 including an accumulator 160 and a splicer 165, a tensioning subsystem 171 including, in this exemplary embodiment, a velocimeter or speed sensor 170, a tension sensor (e.g., a load cell and the like) 172, a thickness sensor 173 and a tensioning device 174. In this exemplary embodiment, material peeling system 150 additionally includes a coiling subsystem 180 including the coiled product 154. In some embodiments, coiling subsystem 180 comprises a coiling motor 182 to facilitate the coiling of the peeled material in the form of the finished product 154. Tensioning device 174 and/or coiling motor 182 may be controlled by a closed-loop controller of material forming system 150. In some embodiments, material peeling system 150 may not include a separate tensioning device and instead the coiling subsystem 180 may comprise the tensioning device 174 of system 150. The term “peeled material” is used herein to refer to material (ferrous or non-ferrous) of varying shapes and sizes that has been peeled from a piece of raw material. Peeled material may also be referred to herein as “peeled strip” or “peeled strips” which again may have a variety of shapes and sizes.

As will be described further herein, material peeling system 150 includes many unique features of the apparatus and methods of operation over previous attempts at developing a practical and useful material peeling system that make the material peeling system 150 relatively more efficient and suitable for producing metal strip coils in large volumes with uniform material properties and dimensional quality. For example, material peeling system 150 includes: a novel work-holding and tool-holding arrangement to facilitate peeling of flat strips with varied widths (narrow to wide) and thicknesses; and (a novel strip transport arrangement including a splicing system and a closed-loop tensioning system for real-time control of strip thickness and transport speed during peeling, and coiling. Specific embodiments of various components and subsystems for the material peeling system 150 are discussed below. While they are presented for the specific case of strip, sheet and foil production using the radial peeling configuration, the examples disclosed herein are also broadly applicable to other peeling configurations and generation of non-flat products such as wire, rod, and the like.

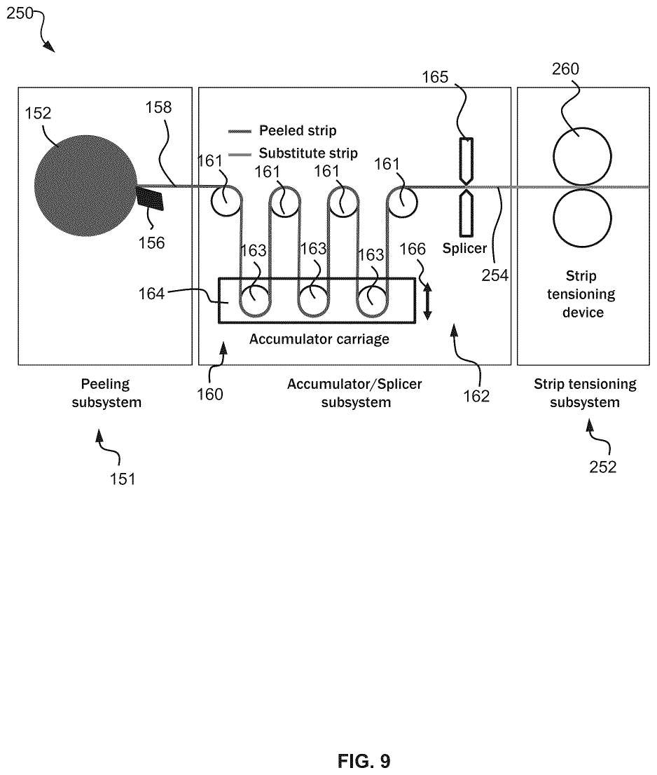

The cutting tool 156 of material peeling system 150 peels the peeled material 158 (e.g., a strip, sheet, wire) from an external surface of feedstock 152 which rotates about a central or longitudinal axis thereof. Accumulator 160 includes a plurality of rollers 161 and 163 which are moveable relative to one another (e.g., upper rollers 161 may move in a first direction while lower roller 163 may move in an opposed second direction). In this exemplary embodiment, rollers 163 are carried on a carriage 164 of accumulator 160 that is transportable rectilinearly in opposing longitudinal directions (e.g., upwards and downwards directions) as indicated by arrow 166 in FIG. 9. As will be described further herein, the position and motion of accumulator carriage 164 may be controlled by an accumulator controller.

In this manner, the length of peeled material 158 received in accumulator 160 may vary over time in order to vary an inlet speed of peeled material 158 received by the accumulator 160 and an outlet speed of peeled material 158 discharged from accumulator 160. Particularly, as rollers 161 move away from roller 163 to increase the capacity of accumulator 160 (e.g., the length of peeled material 158 received by accumulator 160), the speed of peeled material 158 exiting accumulator 160 will decline relative to the speed of peeled material 158 received by accumulator 160. Indeed, if the accumulator 160 increases in capacity at a sufficient rate, the speed of the peeled material 158 exiting accumulator 160 may be temporarily reduced to zero.

Splicer 165 of material peeling system 150 is configured to join or splice a leading or upstream terminal end of peeled material 158 with a trailing terminal end of another strip (e.g., a second strip or peeled material 158). Splicer 165 may only be operated intermittently, such as following a changeout of the feedstock 152. Typically, splicer 165 is configured to splice the leading end of peeled material 158 with the trailing end of the second strip or peeled material while the leading end of peeled material 158 is stationary, and thus accumulator 160 and splicer 165 with accumulator 160 activated to slow the speed of the peeled material 158 exiting therefrom when it is desired to splice the leading end of peeled material 158 with a second strip or peeled material.

The tensioning device 174 applies tension to the peeled material 158 prior to being coiled into the product 154. For example, tensioning device 174 may comprise a plurality of rollers that apply tension to the peeled material 158. The tension applied by tensioning device 174 to peeled material 158 may vary over time. Additionally, the tension applied by tensioning device 174 may be based on data obtained by speed sensor 170, tension sensor 172 and/or thickness sensor 173. As will be described further herein, the tension applied by tensioning device 174 may be controlled by a closed-loop controller which receives as feedback data, data provided by speed sensor 170 and/or tension sensor 172 in order to ensure the characteristics of peeled material 158 conform to desired characteristics of the product 154.

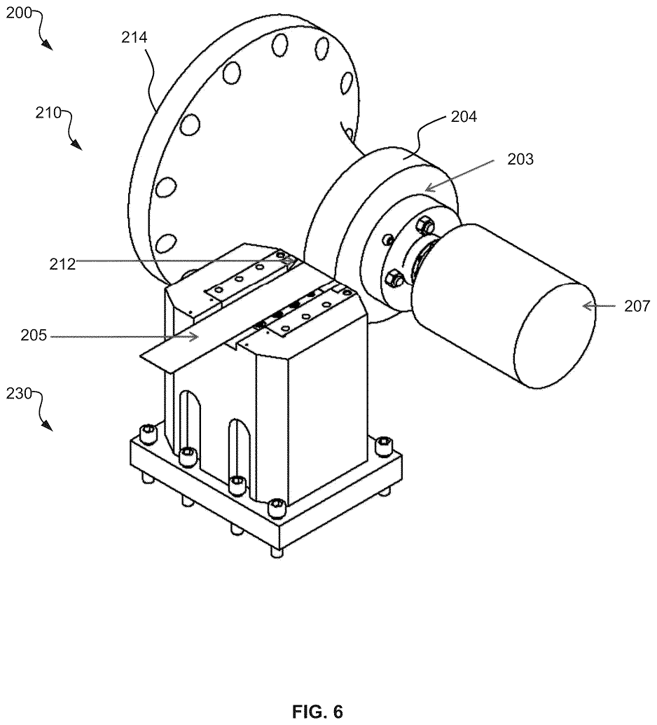

Referring now to FIG. 6, an embodiment of a peeling subsystem 200 is shown. In this exemplary embodiment, the peeling subsystem 200 is configured for forming a thin peeled material or strip 205 from a cylindrical feedstock 203. The peeling subsystem 200 includes both a feedstock holder 210 and a tool support 230.

Generally, the peeling process involves producing the thin peeled material (e.g., a strip) 205 of set thickness from the rotating cylindrical feedstock 203 mounted on a commercial lathe spindle (not shown in FIG. 6). In the radial configuration, this involves feeding a cutting tool with a flat cutting tool edge 212 radially into the feedstock at a constant feed rate (e.g., at a predefined millimeters per revolution (mm/rev)) while the feedstock 203 is rotated such that a constant surface velocity (V₀) of a radially outer surface 204 of the feedstock 203 is maintained. Maintaining a constant surface velocity V₀ ensures that the input velocity at the cutting tool edge 212 remains constant throughout the entire peeling process. Given that the outer diameter of feedstock 204 decreases with time, the rotational speed of the spindle holding the feedstock 204 must be continuously increased during the peeling process to maintain a constant surface velocity V₀. In some embodiments, a constant surface velocity V₀ is maintained using a computer numerical control (CNC) controller of the lathe connected to the feedstock holder 210. The CNC controller may also be used to control the feed rate of the cutting tool edge 212.

Various factors are important for ensuring peeled material 205 meets all desired characteristics, including a uniform and sharp cutting tool edge 212, proper alignment between the cutting tool edge 212 and the outer surface 204 of feedstock 203, and a high system rigidity to mitigate vibration and chatter of the peeling subsystem 200. The term “chatter” refers to the relative oscillatory movement between the feedstock 203 and the cutting tool edge 212 that arises especially under large peeling forces (i.e., large strip widths and thicknesses) due to intrinsic compliance or elasticity in the peeling subsystem 200. An undesirable consequence of chatter is that not only it degrades the performance of peeling subsystem 200 but also leads to periodic, undesired thickness changes in the peeled material 205.

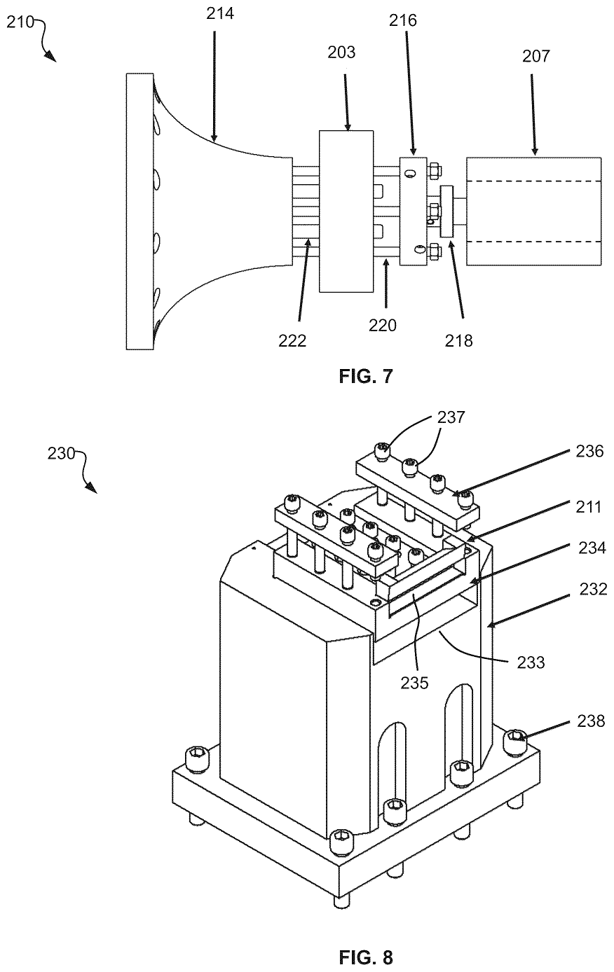

Referring to FIGS. 6-8, the feedstock holder 210 of peeling subsystem 200 is shown in FIG. 7 while the tool support 230 of peeling subsystem 200 is shown in FIG. 8. The feedstock holder 210 of peeling subsystem 200 is responsible for mounting the cylindrical feedstock or feedstock 203 on a commercial lathe for the purpose of producing peeled material 205 (e.g., in the form of a thin metal strip). Feedstock holder 210 generally includes an arbor 214, a pressure plate 216, and a tailstock adapter 218 that couples with a tailstock 207 for supporting the feedstock 203. Arbor 214 comprises an adapter that connects feedstock 203 directly to the lathe spindle (not shown in FIG. 7) for maximum rigidity. One longitudinal end of arbor 214 is attached directly to the spindle typically using fasteners (e.g., screws) while an opposing longitudinal end of arbor 214 comprises a plurality of threaded apertures receiving threaded rods 220 and a plurality of holes for receiving dowel pins 222. Threaded rods 220 connect the arbor 214 to the pressure plate 216 while dowel pins 222 connect arbor 214 to the feedstock 203. Feedstock 203 includes corresponding dowel pin holes for receiving and coupling with dowel pins 222, and clearance holes allowing for the passage of threaded rods 220 through the workpiece 2023. Dowel pins 222 provide additional resistance to prevent slippage between the feedstock 203 and arbor 214 during the peeling process.

Pressure plate 216 of feedstock holder 210 is mounted between feedstock 203 and the tailstock 207 to distribute pressure applied by the tailstock 207 to the feedstock 203 onto a larger area of the feedstock 203 as opposed to a single point on the feedstock 203. The tailstock adapter 218 of feedstock holder 210 facilitates the transfer of pressure from tailstock 207 to feedstock 203, where tailstock adapter 218 is mounted to the tailstock 207 and fits into the pressure plate 216. Particularly, tailstock adapter 218 is fitted into a central opening of the pressure plate 216 using a plurality of fasteners (e.g., screws) mounted radially along the pressure plate 216. In this configuration, when the tailstock 207 is pushed against the feedstock 203, the tailstock adapter 218 exerts a shear load on the radially mounted fasteners, which in turn urges the pressure plate 216 to apply a more uniform pressure across feedstock 203. Consequently, feedstock 203 is sandwiched between the arbor 214 and tailstock 207 under significant pressure applied by tailstock 207 through pressure plate 216. The pressure applied by tailstock 207, together with the support provided by dowel pins 222, results in a highly rigid feedstock holder 210 that prevents slippage of feedstock 203 and is resistant to chatter during the peeling process.

The tool support 230 of peeling subsystem 200 (shown particularly in FIG. 8) is responsible for mounting a cutting tool 211 (comprising the cutting tool edge 212) on a lathe bed for the purpose of producing peeled material 205. Tool support 230 generally includes a base block 232, a tool holder 234, the cutting tool 211, and a pair of tool clamps 236. Base block 232 comprises an adapter that is mounted on a lathe bed (not shown in FIG. 8) and houses the cutting tool 211. The size and dimensions of base block 232 are based on the width of the lathe bed and the center height of the lathe. In addition, base block 232 holds all the other components of tool support 230 and is designed to be as rigid as possible to prevent deflection from the large forces encountered during the peeling process. Fasteners 238 mount the base block 232 directly to the lathe bed.

In this exemplary embodiment, base block 232 includes a pocket 233 at a vertically upper end thereof to support a bottom and opposing sides of the tool holder 234 while providing unobstructed access to a front of the tool holder 234 so as to not interfere with the peeling process. Tool holder 234 is received in pocket 233 and is fixed to the base block 232 via fasteners. Tool holder 234 contains a rectangular pocket 235 for supporting the cutting tool 211. In addition, a small lip is provided at a front of pocket 235 to prevent cutting tool 211 from accidentally slipping from the tool holder 234.

In this exemplary embodiment, cutting tool 211 is secured to the tool holder 234 and the base block 232 by the pair of tool clamps 236 which apply uniform pressure against the sides of the cutting tool 211. In this exemplary embodiment, tool clamps 236 include a plurality of clearance apertures that receive fasteners 237 to secure the tool holder 234 and the base block 232. Cutting tool 211 does not include any mounting apertures and is only supported by the pocket 235 of tool holder 234 from below and the pair of tool clamps 236, permitting for convenient replacement of cutting tool 211. In this manner, cutting tool 211 is substantially prevented from moving or vibrating during the peeling process while allowing for unimpeded flow of peeled material 205 and the convenient replacement of cutting tool 211 as needed.

As described above, peeling subsystem 200 may be used to peel material from a rotating feedstock. In some embodiments, peeling subsystem 200 may be employed to peel various ferrous and non-ferrous metals and alloys, including but not limited to copper alloys, aluminum alloys and steels.

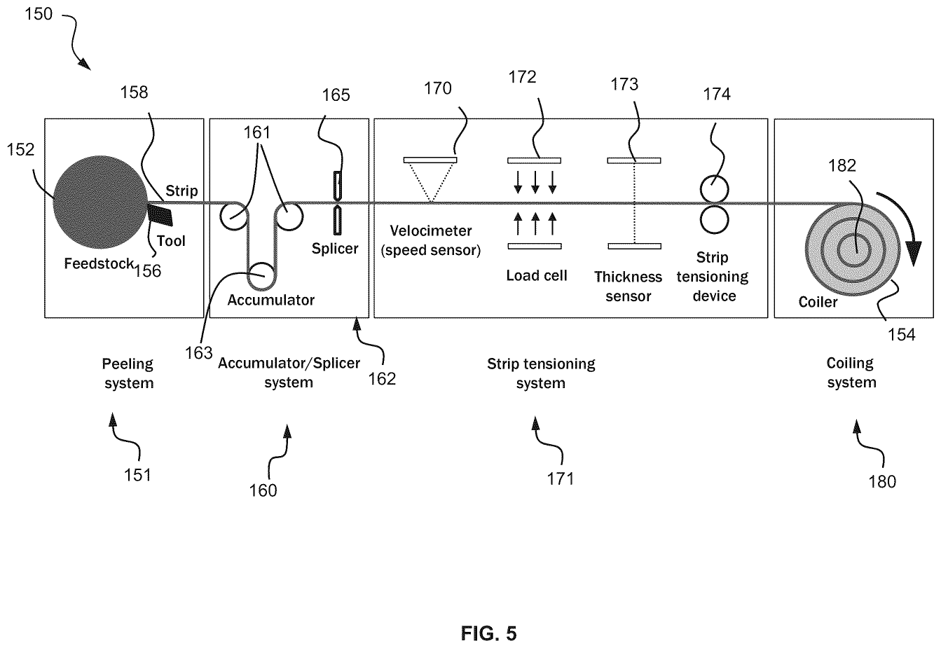

Referring again to FIG. 5, as described above, splicer 165 and accumulator 160 may be used to join a leading terminal end of peeled material 158 with a trailing terminal end of other thin material. The process of weaving the peeled material 158 through multiple subcomponents between the point of peeling (e.g., performed by the peeling subsystem 151) and the point of coiling (e.g., performed by the coiling subsystem) is referred to “strip threading.” Strip threading is an important step during the start-up phase of the peeling process and may be achieved by capturing the edge of the peeled material generated at the cutting tool edge, transporting the peeled material along a predefined path, and then wrapping the peeled material around a coiler. Although strip threading can be done manually, it is not feasible with wider strips or at higher peeling speeds and temperatures. Additionally, manual strip threading poses safety concerns when a human operator is involved. In view of this, the system 250 provides an automatic or semi-automatic strip threading system comprising accumulator 160 and splicer 165 of splicing subsystem 162.

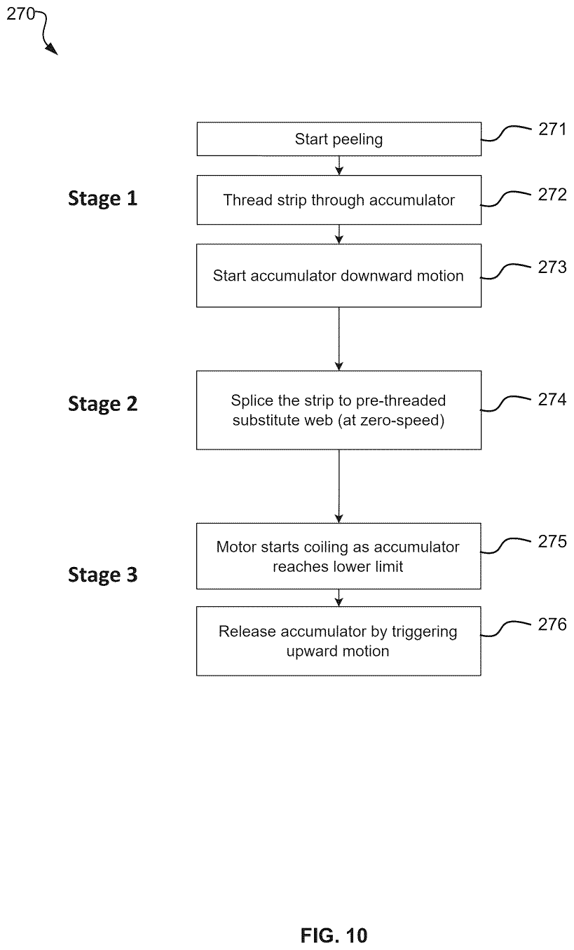

Referring to FIGS. 9-13, another embodiment of a material peeling system 250 is shown in FIGS. 9 and 11-13. Additionally, FIG. 10 illustrates an exemplary method 270 for forming a finished product comprising peeled material and which may be implemented using material peeling system 250. Material peeling system 250 includes features in common with material peeling system 150 shown in FIG. 5, and shared features are labeled similarly. Particularly, material peeling system 250 includes peeling subsystem 151, splicing subsystem 162, and a tensioning subsystem 252 including a tensioning device 260.

Upon startup of material peeling system 250, splicing subsystem 162 is configured to join the leading edge of peeled material 158 to an already pre-threaded substitute strip 254. The advantage of splicing is that it eliminates the problem of threading the peeled material 158 through the entire predefined path. However, to achieve best results, splicing must typically be performed without interrupting the peeling process and the leading edge of peeled material 158 must be joined to a substitute strip 254. Accumulator 160, situated between the peeling subsystem 151 and splicer 165, collects and temporarily stores the peeled material 158 that is continuously being peeled from feedstock 152 during the time of splicing, facilitating lower speed of a leading edge or end 159 to enable zero-speed splicing with a stationary substitute strip or a flying splice with the substitute strip.

As described above, accumulators (e.g., accumulator 160) are temporary material storage devices that can be used to enable splicing (e.g., via splicer 165) without interrupting the upstream peeling process (e.g., performed by peeling subsystem 151). In the following, an exemplary accumulator operation, particularly for the extreme case of zero-speed stationary splice is presented.

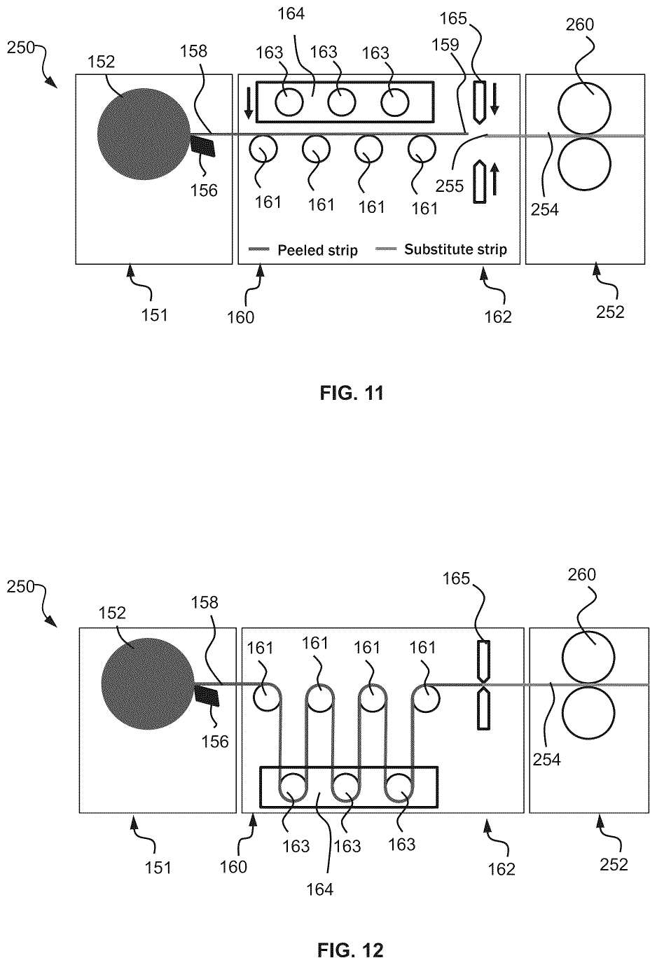

Particularly, in this exemplary embodiment, method 270 is divided into three separate stages including a first stage including blocks 271-273, a second stage including block 274, and a third stage including blocks 275 and 276. Method 270 may of course vary in other embodiments from how it is presented in FIG. 10. FIG. 11 illustrates material peeling system 250 implementing the first stage of method 270. Initially, at block 271 of method 270, peeling is initiated. At block 272, the peeled material or strip (e.g., peeled material 158) formed following the implementation of block 271 is fed through an accumulator (e.g., accumulator 160). At block 273, the accumulator is activated whereby one or more elements (e.g., rollers 163) thereof travel downwards. Initially, during implementation of the first stage of method 270 as shown particularly in FIG. 11, accumulator 160 is in an unengaged state where rollers 163 are spaced from rollers 161 and a leading end 159 of peeled material 158 passes over rollers 161 towards the splicer 165.

FIG. 12 illustrates material peeling system 250 implementing the second stage of method 270. At block 274, method 270 includes splicing the peeled material to a pre-threaded substitute web (e.g., pre-threaded substitute strip 254) at zero speed. To initiate splicing (the second stage of method 270), accumulator 160 is activated from the unengaged state to an engaged state whereby rollers 163 pass across or through the roll of rollers 161 and into contact with the peeled material 158. In this exemplary embodiment, rollers 163 are coupled to the moveable carriage 164 of accumulator 160 such that they may be linearly displaced relative to rollers 161. Thus, in this exemplary embodiment, rollers 163 comprise moveable rollers while rollers 161 comprise stationary rollers. The speed of carriage 164 may be based on the incoming speed of peeled material 158 whereby the leading end 159 of peeled material 158 remains stationary with respect to a trailing end 255 of the substitute strip 254. Particularly, the speed of leading end 159 slows such that leading end 159 comes to a stop directly adjacent the trailing end 255 of substitute strip 254 at the splicer 165. In this position, splicer 165 is activated to join the leading end 159 of peeled material 158 to the trailing end 255 of substitute strip 254 such that peeled material 158 is coupled end-to-end to the substitute strip 254.

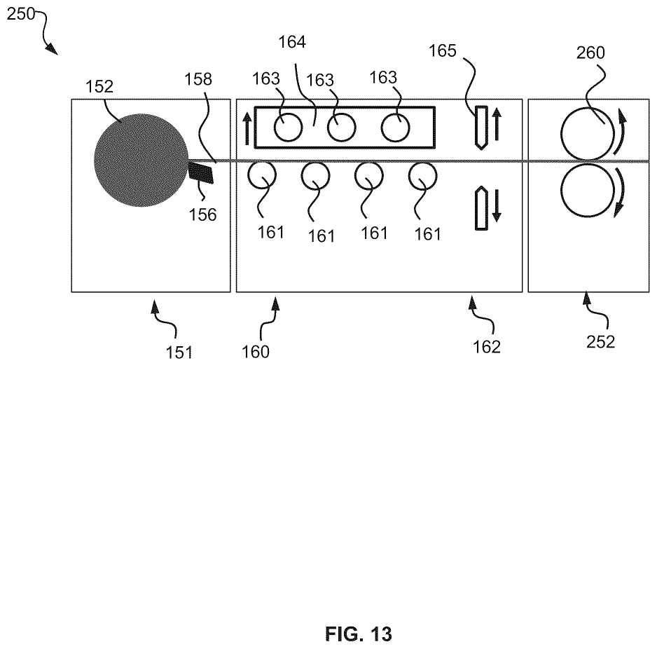

FIG. 13 illustrates material peeling system 250 implementing the third stage of method 270. At block 275, method 270 includes activating a motor for coiling the material as the accumulator reaches a lower limit. At block 276, method 270 includes releasing the accumulator to trigger upwards motion in the elements that had previously moved downwards. Following splicing, in the third stage of method 270, a winding motor of a coiler of material peeling system 250 is activated to pull the peeled material 158 into and through the tensioning subsystem 252 and the accumulator 160 is returned to its disengaged state.

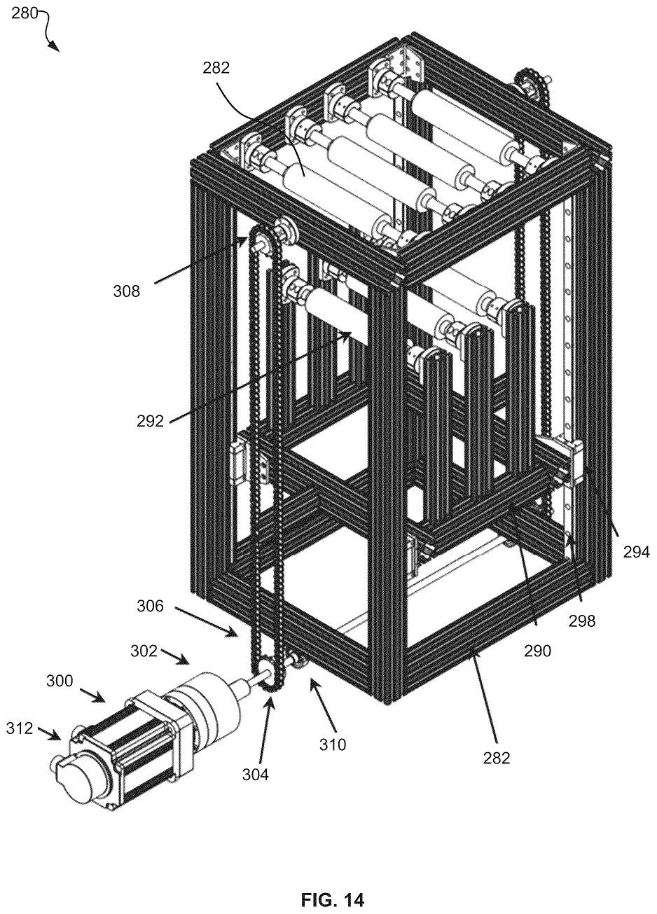

Referring to FIG. 14, an embodiment of an accumulator 280 of a material peeling system is shown. In some embodiments, the accumulator 160 shown in FIGS. 5 and 9 and 11-13 may be configured similarly as the accumulator 280; however, in other embodiments, accumulator 160 may vary in configuration from accumulator 280. Accumulator 280 generally includes a stationary support frame 282, a plurality of stationary idler rollers 285 mounted in a row along a vertically upper end of the support frame 282, a carriage 290 received in the support frame 282, and a plurality of transportable idler rollers 292 mounted in a row to the carriage 290. Additionally, support frame 282 comprises one or more elongate guide rails 284 extending from a vertically lower end to the vertically upper end of the support frame 282. Carriage 290 comprises one or more connectors 294 that slidably connect to the guide rails 284. For example, connectors 294 may each comprise a central groove in which one of the guide rails 284 is received.

Accumulator 280 additionally includes a motor 300 (e.g., an electric motor) configured to selectably drive a drive gear 304 via a gearbox 302 connected between the motor 300 and drive gear 304. Drive gear 304 drives the motion of a continuous flexible member (e.g., a roller chain, a belt) 306 coupled to the carriage 290 and that extends around the drive gear 304 located at the lower end of support frame 282 and an idler gear 308 located at the upper end of support frame 282. The drive gear 304 is supported by a bearing 310 also located at the lower end of frame 282. In some embodiments, accumulator 280 includes an additional drive gear 304, flexible member 306, and idler gear 308 located at an opposing side of the support frame 282. Accumulator 280 additionally includes a motor encoder 312 coupled to the motor 300 for estimating a rotational speed and/or angular position of an output shaft of the motor 300.

Accumulator 280 is shown in FIG. 14 with transportable idler rollers 292 positioned vertically beneath the stationary idler rollers 285 with carriage 290 occupying a vertically lower position within the support frame 282. During operation, motor 300 may be operated to transport carriage 290 vertically upwards towards the upper end of support frame 282 whereby transportable idler rollers 292 may pass through openings 283 formed between the stationary idler rollers 285 such that transportable idler rollers 292 are located vertically above stationary idler rollers 285. Carriage 290 may continue to travel vertically upwards until it occupies a vertically higher position within stationary frame 282. Depending on the configuration of the accumulator 280 with respect to the predefined path of the transported peeled material, the accumulator 280 shown in FIG. 14 may be in an engaged or disengaged state. Further, in this exemplary embodiment, accumulator 280 is designed such that after a splicing operation, carriage 290 is completely disengaged from the peeled strip (not shown in FIG. 14) and the peeled strip proceeds to the tensioning subsystem. In some embodiments, the vertical position of carriage 290 within support frame 282 may be inferred from encoder 312.

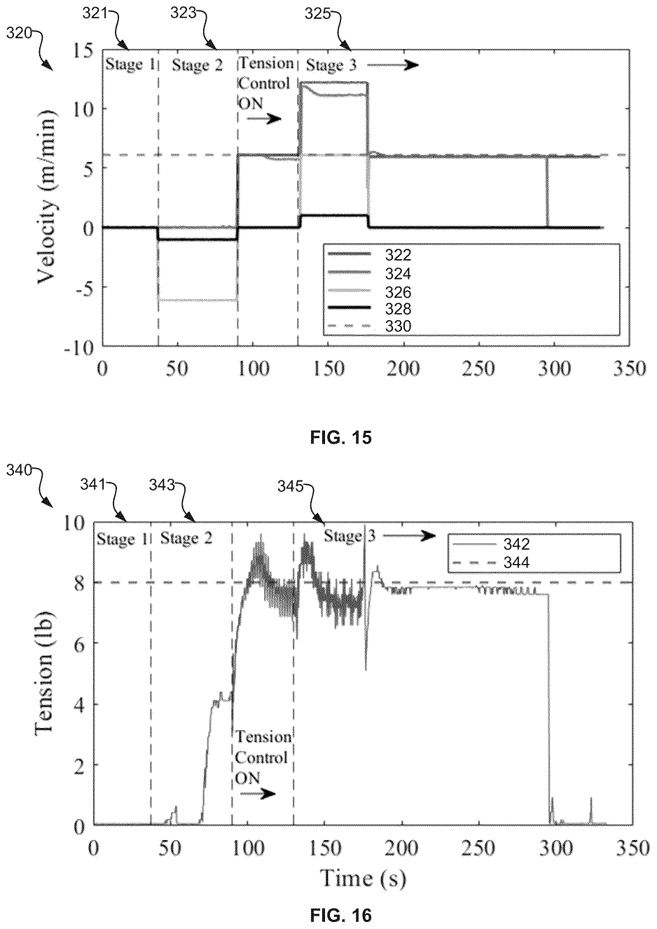

In some embodiments, the process of splicing peeled material using a splicing subsystem of a material peeling system may be broken down into discrete stages. FIG. 15 includes a graph 320 that illustrates velocity (in meters per minute (m/min)) as a function of time (in seconds (s)) of several parameters of an exemplary material peeling system; particularly, graph 320 illustrates reference winding surface velocity 322, feedback winding surface velocity 324, feedback strip accumulation velocity 326, feedback accumulator carriage velocity 328, and lathe exit strip velocity 330. In addition, FIG. 16 illustrates a graph 340 that includes feedback strip tension 342 and desired strip tension 344 across three different stages 341, 343, and 345.

Graph 320 illustrates a first stage 321 in which a carriage of an accumulator (e.g., accumulator 280 shown in FIG. 14) and a coiling motor (e.g., coiling motor 182 shown in FIG. 5) are stationary, and a peeled material or strip (e.g., peeled material 158 shown in FIG. 5) passes through the accumulator to a splicer (e.g., splicer 165 shown in FIG. 5).

Directly following first stage 321, graph 320 illustrates a second stage 323. In this exemplary embodiment, during the second stage 323, the carriage of the accumulator travels downwards (indicated by negative carriage velocity 328) (transitioning from the disengaged state to the engaged state) while the coiling motor remains stationary. In addition, in this exemplary embodiment, the strip is spliced by the splicer at zero velocity to an existing substitute strip. Following splicing, the coiling motor is activated or turned “ON” with the accumulator carriage now stationary in order to achieve a predefined setpoint tension in the strip.

Directly following second stage 323, graph 320 illustrates a third stage 325. In this exemplary embodiment, initially at the third stage 325, the accumulator carriage travels vertically upwards (indicated by positive carriage velocity 328) (transitioning from the engaged state to the disengaged state) while the coiling motor increases in rotational speed to compensate for the net increase in strip velocity (indicated, e.g., by the increased feedback winding surface velocity 324). Once the accumulator achieves the disengaged state, tension regulation is achieved and coiling of the strip continues uninterrupted at approximately the desired strip tension.

Referring again to FIG. 5, in different embodiments, splicing of the peeled material to another elongate material (e.g., a substitute strip) may be accomplished manually, automatically or semi-automatically. Specific embodiments of the splicer 165 of splicing subsystem 162 may vary in the method of splice (mechanical, chemical, electro-mechanical, etc.) or the mode of operation (pneumatic, electric, hydraulic mechanisms, etc.), but enable a means for joining the peeled strip with another substitute material.

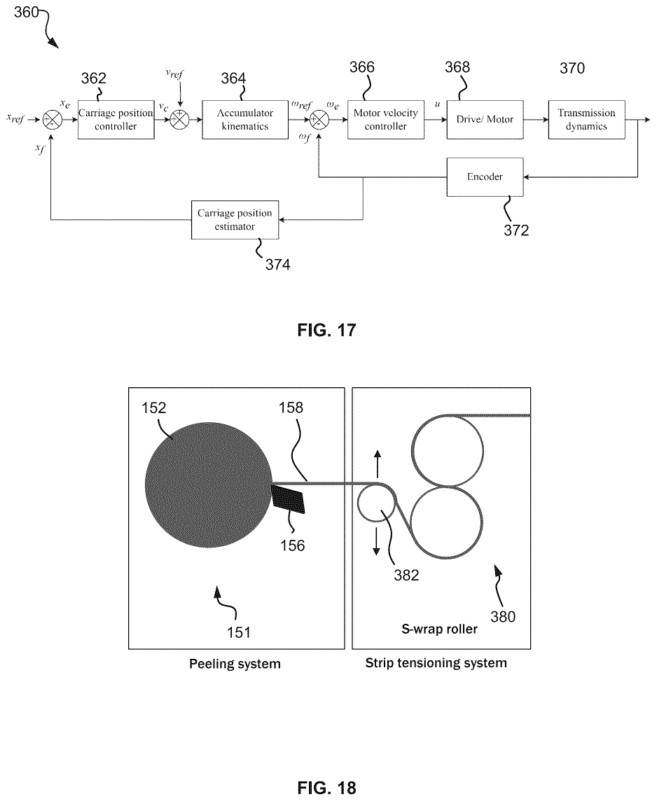

During any stage involving accumulator carriage motion (e.g. second stage 323 shown in graph 320 of FIG. 15), the accumulator requires accurate control of its carriage velocity to match the peeled strip velocity and thereby enable the splicing operation. Referring to FIG. 17, an exemplary closed-loop controller 360 is shown for controlling the operation of an accumulator (e.g., accumulator 160 shown in FIG. 5) of a material peeling system. Closed-loop controller 360 may also be referred to herein as accumulator controller 360 or carriage position controller 360 and is implemented by a computer system. In this exemplary embodiment, the control scheme for the motion of a carriage of the accumulator includes implementing two feedback control systems to control the position and velocity of the carriage between any two reference points.

In this exemplary embodiment, difference between a position reference x_{ref} and the position feedback x_{f}, also called the position error xₑ serves as the input signal to a carriage position controller module 362 of accumulator controller 360. The carriage position controller determines a corresponding velocity correction v_{c} which is then summed with a velocity reference v_{ref} for the motion of the carriage, with the resulting sum thereof inputted to an accumulator kinematics module 364 of accumulator controller 360 to thereby determine a rotational speed reference ω_{ref}. In some embodiments, velocity reference v_{ref} is obtained from the strip velocity upstream of the accumulator (e.g., the peeling end of the peeled material) and downstream from the accumulator (e.g., the splicing end of the peeled material). The velocity reference v_{ref} is equal to the difference between these upstream and downstream strip velocities divided by number of spans captured by the accumulator carriage (e.g., the accumulator 280 shown in FIG. 14 includes are six spans). During zero-speed splicing, the downstream strip velocity is zero.

In this exemplary embodiment, a difference is taken between the estimated rotational speed reference ω_{ref} and a rotational speed feedback ω_{f} to thereby calculate a ωₑ. In this exemplary embodiment, the calculated ωₑ is inputted to a motor velocity controller module 366 of accumulator controller 360 to thereby estimate an input torque u. The estimated u is subsequently inputted to a drive/motor module 368 of accumulator controller 360. The accumulator carriage motion is a result of the response of the particular transmission dynamics (module 370 in FIG. 17) corresponding to an embodiment of the accumulator.

During motion of the accumulator carriage, an encoder module 372 (e.g., corresponding to or interfacing with encoder 312 shown in FIG. 14) of accumulator controller 360, measures the rotational speed feedback ω_{f} provided as feedback data to the difference junction that also receives rotational speed reference ω_{ref}. In addition, the rotational speed feedback ω_{f} is provided to a carriage position estimator module 374 of accumulator controller 360. Carriage position estimator module 374 estimates the position feedback X_{f} based on the inputted ω_{f} provided by encoder module 372, where the position feedback x_{f} is provided as feedback data to the original difference junction that also receives the position reference x_{ref}.

The thickness of the peeled material produced by a material peeling system is sensitive to various factors including starting microstructure of the feedstock and cutting tool edge condition, meaning that any microstructural inhomogeneities in the feedstock or temporal changes in the tool edge condition (inevitable during the peeling process due to tool wear) may result in non-uniform thickness and geometric properties along the peeled material. Referring now to FIG. 18, a tensioning device 380 is shown to address this issue. Particularly, tensioning device 380 maintains constant strip speed, thickness and/or tension of the peeled material 158 based on real-time (e.g., within one second, within 0.10 seconds, within 0.01 seconds) information of the strip state to ensure that the strip thickness remains uniform even in the presence of process disturbances such as, for example, changes in the material state of feedstock 152, the condition of cutting tool edge of cutting tool 156, lubrication.

Tensioning units described herein share features common with the tensioning subsystem 171 in FIG. 5. Generally, embodiments of tensioning devices (e.g., tensioning devices 380, 385, 390 shown in FIGS. 18-20) described herein include a set of idle rollers for passage of the peeled material 158 where the number and size of which depend on the material and dimensions of peeled material 158. The position of a first idle roller 382 past the cutting tool 156 in the determined path of the peeled material 158 can be moved vertically to adjust the angle β at which the peeled strip is pulled by the tensioning device. Embodiments of tensioning devices described herein may also include in-line thickness, speed and load/tension sensors that provide real-time information of the strip thickness t_{c}, speed v_{c}, and tension T at high frequencies. Additionally, embodiments of tensioning devices disclosed herein may include a tensioning device to regulate strip speed, thickness and/or tension. Further, embodiments of tensioning devices disclosed herein may include a programmable logic controller (PLC) for controlling strip speed and tension based on real-time data from sensors (e.g., in-line thickness, speed and load sensors) of the tensioning device.

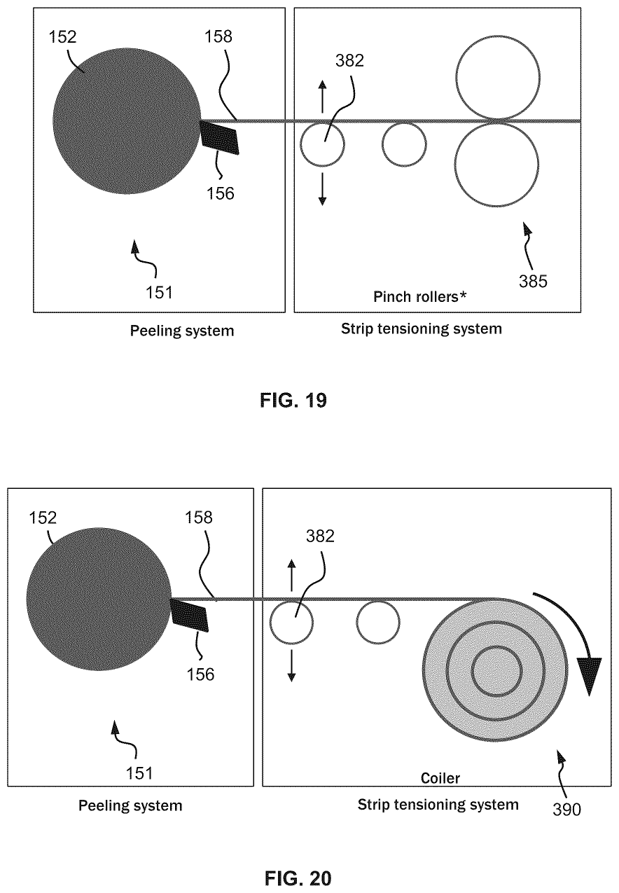

As described above, the configuration of the tensioning device 380 may vary. In the exemplary embodiment shown in FIG. 18, tensioning device 380 comprises an S-wrap roller. Referring briefly to FIGS. 19 and 20, alternative embodiments of tensioning devices 385 (FIGS. 19) and 390 (FIG. 20) are shown. Particularly, tensioning device 385 comprises a pair of pinch rollers (e.g., a rolling mill or nip rollers that may or may not affect thickness reduction of peeled material 158). Additionally, tensioning device 390 comprises a coiler (e.g., including a coiling motor). The coiler of tensioning device 390 is configured to both control strip speed, thickness and/or tension as well as facilitate winding of the peeled material 158 into a coil.

Not intending to be bound by any particular theory, strip thickness t_{c} and speed V_{c} of peeled material 158 are related to each other through the following relationship: t_{c}=t₀V₀/V_{c} such that, for a given t₀ and V₀, strip thickness can generally be controlled by controlling V_{c}. Here, V_{c} represents the strip speed of peeled material 158 at the point where peeled material 158 exits the cutting tool 156. However, dependence of t_{c} on the strip tension T is more complex and typically requires empirical determination through experiments. By controlling the strip tension, it is possible to influence the strip thickness, providing an additional means of regulation.

In some embodiments, strip tension of peeled material 158 may be measured using a load cell (e.g., tension sensor 172 shown in FIG. 5) that utilizes, for example, four foil strain gauges in a full Wheatstone bridge arrangement integrated into the processing line by mounting the load cell behind or underneath an idler roller. Such an idle roller with a mounted load cell is referred to herein as the load cell roller. In some embodiments, the load cell roller is positioned between two other idle rollers along the path of peeled material 158 to maintain a constant wrap angle (preferably large in some embodiments, about ~140-180 degrees) around the load cell roller. This configuration maintains a substantially constant wrap angle during the entire peeling process regardless of the changing feedstock 152 or coil diameter. In some embodiments, the load cell roller includes a load cell amplifier (e.g., a digital amplifier) where the relationship between an output of the load cell amplifier and strip tension of peeled material 158 may be initially inferred (e.g., during calibration of the load cell roller) by, for example, hanging different weights on either side of the load cell roller and comparing the output signals against the known tension values.

To ensure the production of peeled strip with consistent and uniform thickness and shape, precise control must be maintained over the strip tension, strip transport velocity downstream of the peeling process, or both. To achieve precise control over the strip transport speed and tension, various control strategies can be employed. These strategies can be broadly classified into three categories: (1) strip transport velocity regulation to maintain desired strip thickness, (2) strip tension regulation to control strip thickness based on real-time tension feedback, and (3) direct strip thickness control based on thickness feedback.

In some embodiments, the thickness of the peeled material 158 is controlled by maintaining a desired strip transport velocity (V_{c}). The tensioning device (e.g., tensioning devices 380, 385 and 390 shown in FIGS. 18-20) is employed to ensure that the strip is transported at a consistent speed downstream of the peeling process, mitigating fluctuations in strip thickness. The tensioner is driven using a motor through a drive to maintain a constant surface velocity (Vₛ≈V_{c}) for either constant (corresponding to 380 and 385) or time-varying (corresponding to 390) radius of the tensioner. The aforementioned speed control can be implemented using either encoder feedback from the motor or readings from a speed sensor measuring the velocity of the moving strip. Subsequent description is made for the generalized exemplary case of varying radius (e.g., tensioning device 390 shown in FIG. 20).

Particularly, the surface velocity (Vₛ) of the coiled peel material 158 depends on the diameter (D) of the coiled peel material 158 and the rotational speed (ω) of the winding motor of the coiler. Given that the diameter D of the coiled peel material 158 increases over time, maintaining a constant Vₛ requires continuously decreasing rotational speed ω.

In certain embodiments, continuously decreasing rotational speed ω so as to maintain a constant surface velocity Vₛ may be achieved by controlling rotational speed ω based on a continually observed or estimated, time-varying diameter D. Diameter D may be estimated using an encoder that accurately (e.g., ~1/10,000 revolutions) tracks the total number of revolutions the winding motor of the coiler has undergone. Based on data provided by the encoder, the diameter D may be updated by adding two times the thickness of the peeled material 158 to the previously estimated diameter each time a complete rotation of the winding motor is completed. For example, if the initial diameter D equals D₀, then following a full rotation of the winding motor, the diameter D increases by 2t_{c} whereby diameter D now equals D1 or (D₀+2t_{c})—requiring a corresponding change in rotational speed ω to maintain a constant Vₛ.

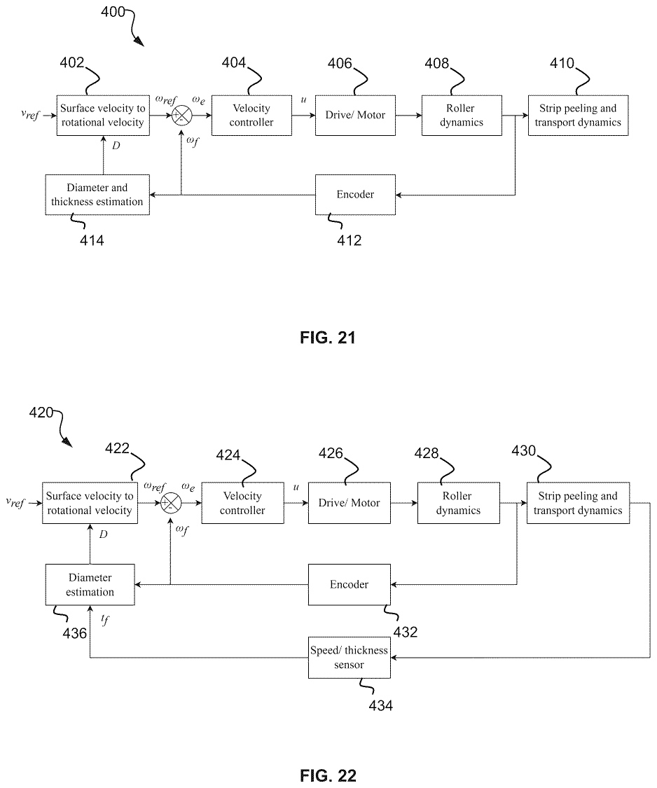

Referring to FIG. 21 an embodiment of a closed-loop speed controller 400 for a material peeling system is shown. In this exemplary embodiment, a reference surface velocity v_{ref} of the peeled material (e.g., peeled material 158 shown in FIG. 5) and an estimated current diameter D of the coiled peeled material are inputted to a surface velocity to rotational velocity conversion module 402 of speed controller 400 to thereby determine a reference rotational speed ω_{ref} of the winding motor of the coiler (e.g., the coiler of tensioning device 390 shown in FIG. 20). In some embodiments, the reference surface velocity V_{ref} of the peeled material corresponds to a setpoint surface velocity of the peeled material.

Difference between the reference rotational speed ω_{ref} and a measured ω_{f} is taken to calculate a rotational speed error ωₑ that is inputted to a velocity controller module 404 of speed controller 400. The velocity controller module 404 determines an input torque u that is subsequently inputted to a drive/motor 406 (e.g., for controlling the winding motor). A driven roller responds to the aforementioned torque input u, in accordance with the modeled and/or unmodeled dynamics 408, and the corresponding roller velocity is measured using an encoder module 412. The encoder module 412 measures the rotational speed feedback ω_{f} that is compared with the reference rotational speed ω_{ref} as described above as well as provides feedback data to a diameter and thickness estimation module 414 of speed controller 400 that estimates the diameter D of the coiled peeled material and thickness to of the peeled material 158.

In other embodiments, a substantially constant Vₛ may be maintained by instead monitoring an exited speed of the peeled material 158 proximate the edge of cutting tool 156 via an in-line speed sensor (e.g., a contact or non-contact-based sensor), comparing the exit speed with a desired exit speed, and controlling the surface velocity Vₛ of the coiled peeled material 158 to compensate for any difference between the monitored exit speed and the desired exit speed.

Referring to FIG. 22, another embodiment of a closed-loop speed controller 420 for a material peeling system is shown. Particularly, speed controller 420 is an example of a speed controller configured to implement the speed control strategy described in the preceding paragraph but which includes additional sensor(s) for measuring/estimating the thickness and/or speed of the peeled material 158.

Particularly, an encoder module 432 of speed controller 420 determines a rotational speed feedback w/that is compared with the reference rotational speed ω_{ref} as described above as well as being provided as feedback data to a diameter estimation module 436 of speed controller 420 that estimates the diameter D of the coiled peeled material. Further, the speed/thickness sensor module 434 estimates a thickness t of the peeled material that is used to estimate diameter along with the rotational speed feedback ω_{f} by the estimation module.

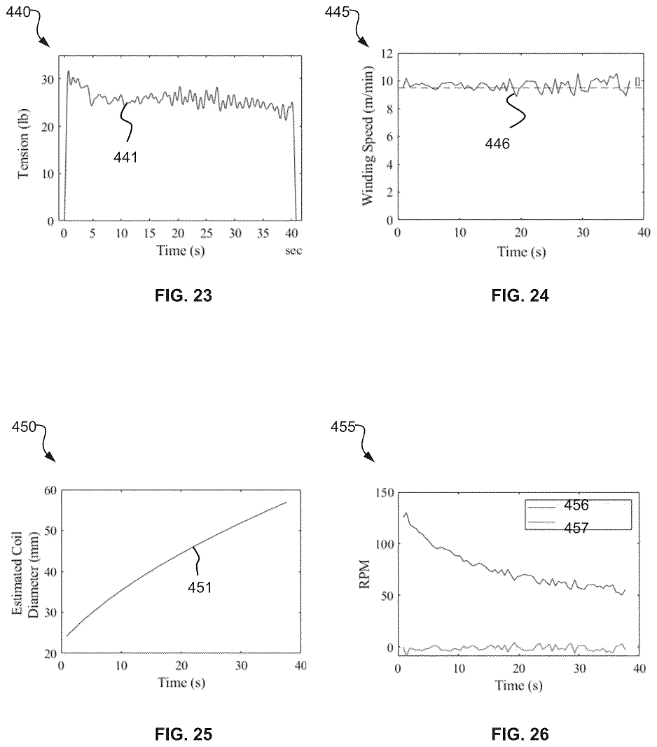

Referring to FIGS. 23-26, graphs 440, 445, 450, and 455 are shown respectively, illustrating data of an exemplary implementation of one of the speed controllers (e.g., speed controllers 400 and 420 shown in FIGS. 21 and 22) described herein. Particularly, graph 440 illustrates exemplary tension 441 of the peeled material over time (maintained substantially at 25 lb in this example); graph 445 illustrates exemplary surface speed 446 of the peeled material over time (maintained substantially at 9.5 meters per minute (m/min) in this example); graph 450 illustrates an exemplary estimated coil diameter 451 of the coiled peeled material over time; and graph 455 illustrates exemplary feedback rotational speed 456 and exemplary rotational speed error 457 (e.g., of the winding motor) over time.

As described above, in at least some embodiments, another control strategy involves regulating the strip tension to control the strip thickness based on real-time tension feedback. In embodiments where the relationship between the tension of the peeled material and thickness is known a priori, the desired thickness of the peeled material can be achieved by specifying a predefined tension and maintaining the tension of the peeled material at the predefined tension. Tension of the peeled material is monitored and controlled by the material peeling system, such as by a computer-implemented tension controller thereof.

In certain embodiments, the tension controller of the material peeling system monitors tension of the peeled material using an in-line tension sensor in the form of a load cell, to provide real-time measurements of the strip tension. Data produced by the tension sensor may be compared with a predefined setpoint tension to determine a tension error that may be used by the tension controller to compensate for the tension error.

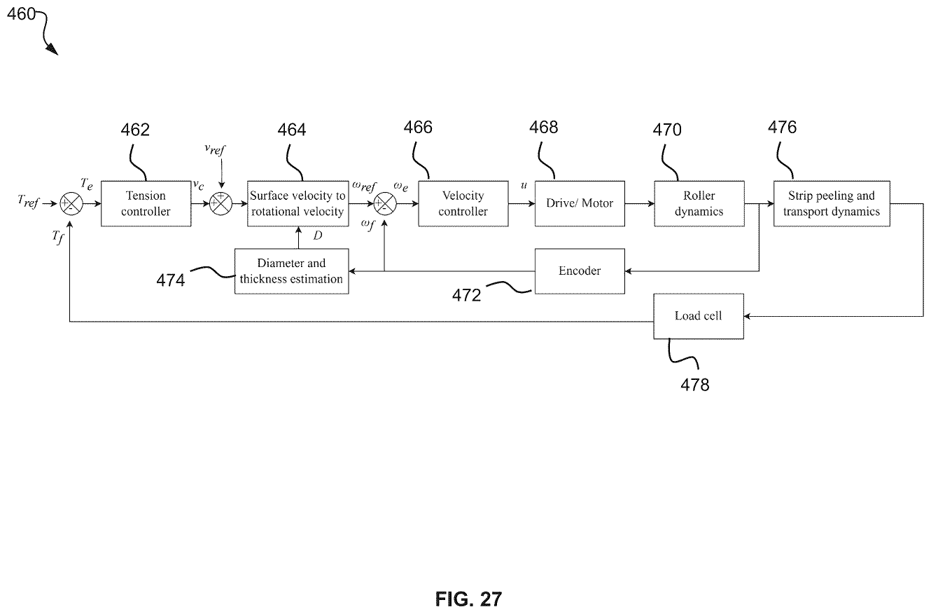

Referring to FIG. 27, an embodiment of a closed-loop tension controller 460 for a material peeling system is shown. Particularly, tension controller 460 is an example of a tension controller configured to implement the tension control strategy described in the preceding paragraph, to control the operation of a tensioning device of the material peeling system.

In this exemplary embodiment, a difference is taken between reference tension T_{ref} of the peeled material (e.g., peeled material 158 shown in FIG. 5) and a measured tension feedback T_{f} of the peeled material to obtain a tension error Tₑ that is inputted to a tension controller module 462 of the tension controller 460. Tension controller module 462 outputs that a velocity correction v_{c} that is summed with a velocity reference v_{ref} before being inputted to a surface velocity to rotational velocity module 464 of tension controller 460 along with a roll diameter D. The difference between the reference rotational velocity ω_{ref} given by Module 464 and feedback rotational velocity ω_{f} is used to compute the error in rotational velocity, ωₑ, that is inputted to a velocity controller module 466 of tension controller 460. Velocity controller 466 outputs an input torque u (e.g., the motor signal) to a drive motor 468 which powers the tensioning device. The driven roller responds to the aforementioned torque input u, in accordance with the modeled and/or unmodeled dynamics 470, subsequently influencing strip formation and transport (476 in FIG. 27).

In this exemplary embodiment, encoder 472 measures the feedback rotational velocity ω_{f} of the said tensioning device, which is based on the roller dynamics as described earlier. Similar to the velocity regulation control strategy, feedback rotational velocity ω_{f} is provided to a diameter and thickness estimation module 474 that outputs the roll diameter D provided to surface velocity to rotational velocity module 464. Additionally, some embodiments of the described tension controller 460 may also use an independent speed/thickness sensor module that estimates the thickness of the peeled material, which is in turn used to calculate the diameter of the peeled coil by the diameter estimation module 474 in addition to the feedback rotational velocity ω_{f}.

In this exemplary embodiment, the resulting strip tension feedback due to the input torque to the motor is measured using a load cell 478 of tension controller 460. The load cell outputs the tension feedback T_{f} referenced above.

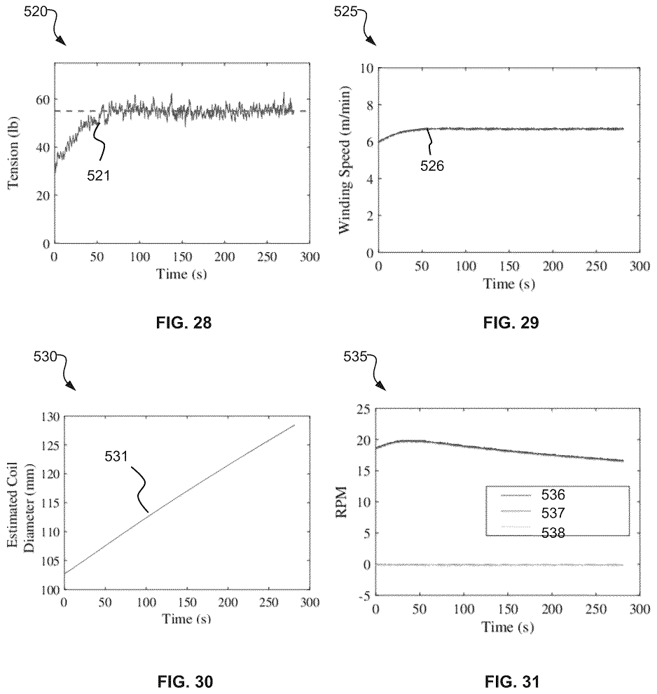

Referring to FIGS. 28-31, graphs 520, 525, 530, and 535 are shown respectively, illustrating data of an exemplary implementation of one of the tension controllers (e.g., tension controller 460 shown in FIG. 27) described herein. In this example, graphs 520, 525, 530, and 535 particularly illustrate tension control applied to a carbon steel peeling operation.

For example, graph 520 of FIG. 28 illustrates exemplary tension 521 of the peeled material (e.g., carbon steel) over time (maintained substantially at a predefined tension setpoint equal to 60 lb in this example); graph 525 of FIG. 29 illustrates exemplary winding speed 526 of the peeled material over time; graph 530 of FIG. 30 illustrates an exemplary estimated coil diameter 531 of the coiled peeled material over time; and graph 535 of FIG. 31 illustrates exemplary feedback rotational speed 536, exemplary reference rotational speed 537, and exemplary rotational speed error 538 (e.g., of the winding motor) over time. The low standard deviation indicated in graph 520 illustrates the feasibility of the process to produce large coils with desired and consistent properties. In some embodiments, the finished coiled peeled material may have an outer diameter hundreds of meters in size.

In addition to controlling strip thickness indirectly through tension or speed control, a direct thickness control strategy can be employed. A direct thickness control strategy facilitates the dynamic adjustment of the tensioner based on real-time thickness measurements. Two exemplary configurations for implementing this strategy are described below.

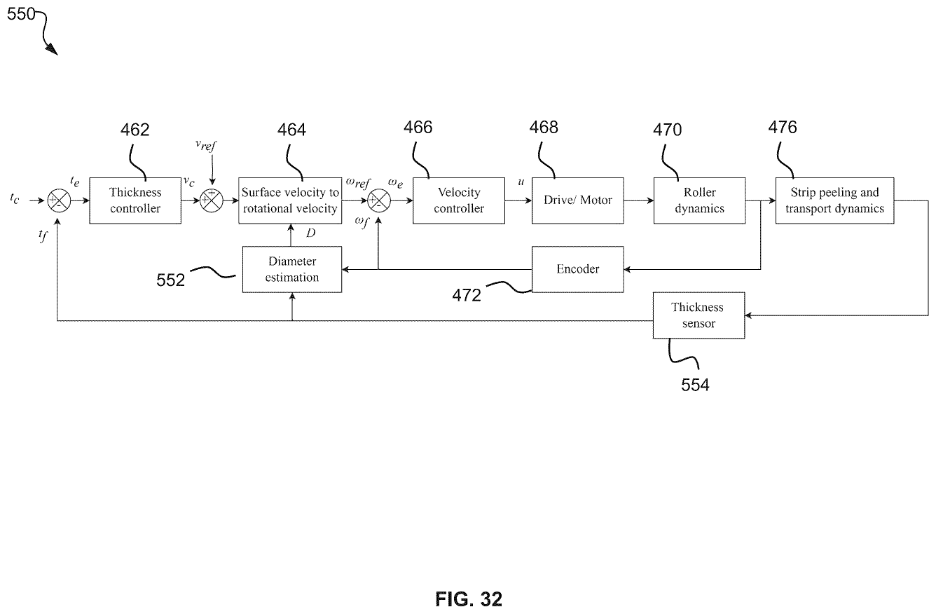

Referring to FIG. 32, an embodiment of a closed-loop controller 550 is shown. Closed-loop controller 550 includes features in common with closed-loop controller 460 shown in FIG. 27 and shared features are labeled similarly. Particularly, in this exemplary embodiment, closed-loop controller 550 includes a diameter estimation module 552 (rather than diameter and thickness estimation module 474) and a thickness sensor 554. Closed-loop controller 550 uses an outer thickness control loop to regulate the strip thickness t_{c} based on real-time feedback from the thickness sensor 554 located downstream of the cutting tool by correcting the strip transport velocity. In this exemplary embodiment, a difference is taken between desired thickness to of the peeled material (e.g., peeled material 158 shown in FIG. 5) and a measured thickness feedback tr of the peeled material to obtain a thickness error tₑ that is inputted to a thickness controller module 462 of closed-loop controller 550. The thickness controller module 462 generates a velocity correction factor, v_{c}, which is added to a velocity reference, v_{ref}. The resulting sum is input, along with a roll diameter, D, to a surface velocity to rotational velocity module 464 of closed-loop controller 550. The module generates a reference rotational velocity, ω_{ref}. This reference is compared to a feedback rotational velocity, ω_{f}, measured by an encoder. The resulting rotational velocity error, ωₑ, is input to a velocity controller module of the controller. The velocity controller outputs a torque input, u, to a drive/motor, which powers the tensioning device. The tensioning device, influenced by modeled and unmodeled dynamics, responds to the torque input u. In this exemplary embodiment, the thickness sensor measures the resulting strip thickness tr referenced above.

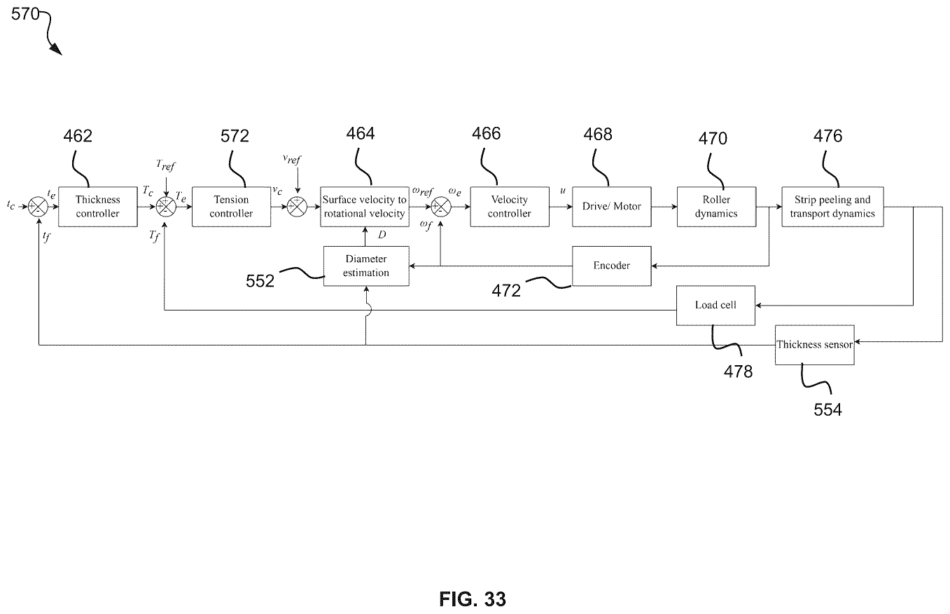

Referring to FIG. 33, an embodiment of a closed-loop controller 570 is shown. Closed-loop controller 570 includes features in common with closed-loop controllers 460 and 550 shown in FIGS. 27 and 32, respectively, and shared features are labeled similarly. Particularly, in this exemplary embodiment, closed-loop controller 570 includes a tension controller 572. Closed-loop controller 570 thus combines thickness feedback with a tension control loop. In this exemplary embodiment, thickness sensor 554 measures the feedback thickness of the peeled material 158. The difference between the desired setpoint thickness t_{c} and the measured feedback thickness is inputted to thickness controller 462. Based on the error, the thickness controller 462 generates a tension reference correction T_{c}, to be added to the tension reference. Load cell 478 located downstream of the peeling tool measures the actual strip tension T_{f}. The tension feedback is compared with the sum of the tension reference T_{ref} and tension correction Tc to compute a tension error Tₑ. The tension error is processed by tension controller 572, which outputs a velocity correction signal v_{c}, which is added to the reference surface velocity and inputted to the surface velocity-to-rotational velocity module. Similar to the previous configuration, the rotational velocity corresponding to a reference surface velocity is computed, and velocity controller 466 is used to generate an input toque, u, to the drive motor 468. The velocity controller 466 generates this torque input based on the rotational velocity error, ωₑ, which is computed from the difference between the reference rotational velocity, ω_{ref} and the feedback rotational velocity, ω_{f}, measured by encoder 472. The strip formation and transport are a result of the motion of the tensioning device in response to the input torque.

Some additional embodiments of all the aforementioned control strategies use a diameter measurement sensor to obtain coil diameter for feedback in lieu of the diameter estimation module, but with the same controller structures described thereof.

In some embodiments, a coiling subsystem or unit of a material peeling system comprises a load cell roller, a guide system, and an airshaft shaft actuated by a controlled motor for mounting removable cores over which metal strip can be continuously coiled. As noted earlier, in some embodiments, the coiling unit utilizes an algorithm that estimates the coil diameter (D) in real-time based on motor encoder data for control of tension and/or speed of the peeled strip. By continuously tracking the coil rotation speed and the strip thickness, coiling unit adjusts its parameters to maintain a set strip speed and/or tension throughout the coiling process, regardless of the coil size. The regulation of strip speed and tension leads to a more controlled operation where the strip thickness can be controlled efficiently; this feature also reduces waste from breaks or deformations while mitigating the occurrence of geometric defects like wrinkles, baggy edges, etc., that can occur due to inconsistent tension control. This strategy overall leads to a coiled strip of consistent properties and quality while meeting required standards.

While embodiments of the disclosure have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1-11. (canceled)

12. A system for forming a peeled material from a rotating feedstock, the system comprising:
a peeling subsystem comprising a cutting tool configured to peel a continuous peeled material from an outer surface of the feedstock;
a tensioning subsystem comprising one or more rollers defining a travel path of the peeled material and a tensioning device for applying tension to the peeled material;
a sensor for determining at least one of surface speed of the peeled material along the travel path, a tension of the peeled material, and a thickness of the peeled material; and
a closed-loop controller comprising a processor and a memory device encoded with instructions that, when executed by the processor, cause the processor to control the operation of the tensioning subsystem to control at least one of the surface speed, the tension, or thickness of the peeled material based on feedback data provided by the sensor.

13. The system of claim 12, wherein the instructions of the closed-loop controller, when executed by the processor, cause the processor to maintain the peeled material for at least one of a predefined setpoint thickness, a predefined setpoint tension, or a predefined setpoint surface speed along the travel path.

14. The system of claim 12, wherein the feedback data comprises tension data and the instructions of the closed-loop controller, when executed by the processor, cause the processor to control the operation of the tensioning subsystem to control the tension of the peeled material.

15. The system of claim 12, wherein the sensor comprises a load cell configured to determine the tension of the peeled material.

16. The system of claim 12, wherein the feedback data comprises thickness data and the instructions of the closed-loop controller, when executed by the processor, cause the processor to control the operation of the tensioning subsystem to control the thickness of the peeled material.

17. The system of claim 12, wherein the sensor is configured to measure the thickness of the peeled material.

18-20. (canceled)

21. The system of claim 12, wherein the travel path extends between and through a pair of the one or more rollers of the tensioning subsystem.

22. The system of claim 12, wherein the wherein the instructions of the closed-loop controller, when executed by the processor, cause the processor to adjust the tension applied by the tensioning subsystem to the peeled material to maintain the peeled material at a predefined setpoint thickness.

23. A system for forming a peeled material from a rotating feedstock, the system comprising:
a peeling subsystem comprising a cutting tool configured to peel a continuous peeled material from an outer surface of the feedstock;
a tensioning subsystem comprising one or more rollers defining a travel path of the peeled material and a tensioning device for applying tension to the peeled material;
a tension sensor for determining a tension applied to the peeled material by the tensioning subsystem; and
a closed-loop controller comprising a processor and a memory device encoded with instructions that, when executed by the processor, cause the processor to control the operation of the tensioning subsystem to control the tension applied by the tensioning subsystem to the peeled material to maintain the peeled material for at least one of a predefined setpoint tension or a predefined setpoint surface speed along the travel path.

24. The system of claim 23, wherein the feedback data comprises at least one of tension data and velocity data of the peeled material and the instructions of the closed-loop controller, when executed by the processor, cause the processor to control the operation of the tensioning subsystem to control at least one of the tension or the velocity of the peeled material.

25. The system of claim 23, wherein the sensor comprises a load cell.

26. The system of claim 23, wherein the feedback data comprises thickness data and the instructions of the closed-loop controller, when executed by the processor, cause the processor to control the operation of the tensioning subsystem to control the thickness of the peeled material.

27. The system of claim 23, wherein the sensor is configured to measure the thickness of the peeled material.

28. The system of claim 23, wherein the instructions, when executed by the processor, cause the processor to control the operation of the tensioning subsystem to control the tension applied by the tensioning subsystem to the peeled material to maintain the peeled material at the predefined setpoint tension.

29. The system of claim 23, wherein the instructions, when executed by the processor, cause the processor to control the operation of the tensioning subsystem to control the tension applied by the tensioning subsystem to the peeled material to maintain the peeled material at the predefined setpoint surface speed along the travel path.

30. A system for forming a peeled material from a rotating feedstock, the system comprising:
a peeling subsystem comprising a cutting tool configured to peel a continuous peeled material from an outer surface of the feedstock;
a tensioning subsystem comprising one or more rollers defining a travel path of the peeled material and a tensioning device for applying tension to the peeled material;
a tension sensor for determining a tension applied to the peeled material by the tensioning subsystem; and
a closed-loop controller comprising a processor and a memory device encoded with instructions that, when executed by the processor, cause the processor to control the operation of the tensioning subsystem to control the tension applied by the tensioning subsystem to the peeled material to maintain the peeled material at a predefined setpoint thickness.

31. The system of claim 30, wherein the sensor comprises a load cell.

32. The system of claim 30, wherein the sensor is configured to measure the thickness of the peeled material.

33. The system of claim 30, wherein the feedback data comprises thickness data.

34. The system of claim 30, wherein the travel path extends between and through a pair of the one or more rollers of the tensioning subsystem.
